(19) United States
(12) Patent Application Publication
(10) Pub. No.: US 2026/0117729 A1
(43) Pub. Date: Apr. 30, 2026

(54) HIGH PRESSURE PUMP WITH BYPASS FLOW FOR LPG FUEL

(71) Applicant: Stanadyne Operating Company LLC, Jacksonville, NC (US)

(72) Inventors: Srinu Gunturu, Lexington, SC (US); Michael Hornby, Emerald Isle, NC (US)

(21) Appl. No.: 19/375,984

(22) Filed: Oct. 31, 2025

Related U.S. Application Data
(60) Provisional application No. 63/714,562, filed on Oct. 31, 2024.

(51) Int. Cl. F02M 21/02

(52) U.S. Cl. CPC F02M 21/0245

(57) ABSTRACT

To prevent vapor lock in a high-pressure fuel pump delivering LPG in a liquid-phase to fuel injectors that inject liquid-phase LPG into the combustion chamber of an internal combustion engine, a fuel system is configured to generate a continuous flow of LPG through the low-pressure side of the high-pressure fuel pump, with a return connection positioned to preferentially direct gaseous-phase LPG back to the fuel tank. A regulating valve in the return line maintains a predetermined fuel pressure at the inlet side of the high-pressure pump, which reduces fuel vaporization issues within the high-pressure pump.

### BACKGROUND

The present description relates generally to a high-pressure fuel pump configured to pump liquid-phase liquified petroleum gas (LPG) to a direct fuel injection (DI) system for a spark-ignited internal combustion engine or other consumer.

Liquefied petroleum gas (LPG), primarily comprised of propane, is commonly used to fuel an internal combustion engine. LPG may be delivered to an engine in various phases (e.g., liquid and gaseous). In some examples, engine systems may only include direct injectors; however, direct injection of LPG may not be suitable under relatively hot conditions because liquid LPG may vaporize. In other examples, engine systems may only include port injectors; however, port injection of LPG may not be suitable under relatively cool conditions because gaseous LPG may condense. To address this issue, some engine systems may include both direct and port injection in what is commonly referred to as port fuel direct injection (PFDI). In such PFDI systems, fuel is lifted from a fuel tank by a lift pump and is then either directly supplied to the port injection fuel rail, or is supplied to a higher pressure direct injection pump before continuing on to the direct injection fuel rail.

However, the inventors herein have recognized potential issues with such fuel injection systems when fueling with LPG. High vapor pressure and hot conditions (hot soak and idle) cause LPG to vaporize inside a high-pressure fuel injection pump. Vaporization inside the pump leads to failure in compressing fuel, resulting in engine stalls, inability to maintain power/torque, and potential catastrophic pump failures.

### SUMMARY OF THE INVENTION

To prevent vapor lock in a high-pressure fuel pump pressurizing liquid-phase LPG for delivery to fuel injectors that directly inject liquid-phase LPG into the combustion chamber of an internal combustion engine, the high-pressure fuel pump and fuel system are configured to generate a continuous flow of LPG through the low-pressure (inlet) side of the high-pressure fuel pump. An outlet for return flow path from the low-pressure side of the high-pressure pump to the LPG tank connection is positioned to preferentially direct gaseous-phase LPG back to the fuel tank while liquid-phase LPG is directed to the inlet control valve of the high-pressure fuel pump. A regulating valve in the return flow path maintains a predetermined fuel pressure at the inlet side of the high-pressure pump, which reduces fuel vaporization issues within the high-pressure pump. The disclosure includes a high-pressure fuel pump modified to separate gaseous-phase LPG from liquid-phase LPG at the inlet of the high-pressure fuel pump and a fuel system including a pressure-regulated return flow path from the inlet of the high-pressure fuel pump to the LPG fuel tank. A regulated pressure at the inlet of the high-pressure fuel pump reduces vaporization of LPG and the return flow path is used to return gaseous-phase LPG to the LPG fuel tank to substantially eliminate cavitation and vapor lock in the high-pressure fuel pump.

The disclosure includes a high-pressure fuel pump comprising an inlet receiving LPG fuel from a fuel tank and communicating with an infeed passage, said LPG fuel comprising a mixture of liquid-phase LPG and gaseous-phase LPG. The high-pressure fuel pump is a piston-type fuel pump with a pumping chamber in selective fluid communication with the infeed passage. A pumping plunger reciprocates in the pumping chamber between an intake phase that expands a volume of the pumping chamber to draw fuel into the pumping chamber and pumping phase that reduces the volume of the pumping chamber to compress fuel to a higher pressure to deliver pressurized liquid-phase LPG through a discharge valve to a high-pressure outlet. According to aspects of the disclosure, the high-pressure fuel pump include a return connection to the LPG fuel tank, where the return connection is in communication with the infeed passage. The infeed passage of the high-pressure fuel pump is configured to direct liquid-phase LPG to flow toward the pumping chamber and gaseous-phase LPG to the return connection.

According to aspects of the disclosure, a first portion of the infeed passage is gravitationally below the pump inlet and the return connection so that liquid-phase LPG descends into the first portion and gaseous-phase LPG flows to the return connection. The disclosed high-pressure fuel pump of includes an inlet valve arranged to open during the intake phase and close during the pumping phase, selectively connecting the pumping chamber to the infeed passage so that liquid-phase LPG flows through the inlet valve, is compressed in the pumping chamber during the pumping phase, and pressurized liquid-phase LPG flows through the high-pressure outlet of the high-pressure fuel pump to downstream consumers of high-pressure liquid-phase LPG such as fuel injectors arranged to inject high-pressure liquid-phase LPG directly into the combustion chamber of an internal combustion engine.

The high-pressure fuel pump may include a seal surrounding the pumping plunger at a position between a pumping end of the plunger situated in the pumping chamber and a driven end of the pumping plunger opposite the pumping end. The infeed passage directs liquid-phase LPG through a seal chamber surrounding the pumping plunger before liquid-phase LPG is delivered to the pumping chamber. The high-pressure fuel pump may include an inlet metering valve in the infeed passage for delivering metered quantities of liquid-phase LPG to the pumping chamber, said inlet metering valve having an inlet metering valve member movable between an open position corresponding to maximum flow and a closed position of the metering valve corresponding to zero flow to the pumping chamber.

The disclosure includes an LPG fuel system for an internal combustion engine including a fuel tank defining a volume for storage of pressurized LPG fuel, the LPG fuel having a liquid-phase at a gravitational bottom of the fuel tank and a gaseous phase at a gravitational top of the fuel tank. A low-pressure supply pump is arranged to pump liquid-phase LPG fuel through a fuel delivery line to the inlet of a high-pressure fuel pump. The high-pressure fuel pump includes an inlet receiving LPG fuel from the fuel delivery line and communicating with an infeed passage, the LPG fuel at said inlet comprising a mixture of liquid-phase LPG and gaseous-phase LPG. The pumping chamber of the high-pressure fuel pump is in selective fluid communication with the infeed passage. The high-pressure fuel pump includes a pumping mechanism such as a pumping plunger that compresses liquid-phase LPG fuel to deliver pressurized liquid-phase LPG through a discharge valve to a high-pressure outlet. The high-pressure fuel pump includes a return connection to the LPG fuel tank where the return connection is in communication with the infeed passage of the high-pressure fuel pump. A return line receives LPG fuel from the return connection and delivers LPG fuel back to the fuel tank, the return line passing through a valve configured to maintain a predetermined LPG fuel pressure between the valve and the infeed passage of the high-pressure fuel pump.

Pressurized liquid-phase LPG is delivered from the high-pressure outlet of the high-pressure fuel pump to fuel injectors arranged to inject liquid-phase LPG fuel directly into combustion chambers of the internal combustion engine. An engine control system monitors engine operating conditions including engine rotational speed and power output. The LPG fuel system may include sensors configured to detect the temperature and pressure of LPG fuel in the return line, and a control system receiving temperature and pressure readings from the sensors and generate control signals. The valve in the return line is configured to vary the fuel pressure between the valve and the inlet of the high-pressure fuel pump depending on control signals from the control system. The low-pressure supply pump may be positioned within the LPG fuel tank and is regulated by the engine control system to deliver LPG fuel at a rate dependent upon the engine operating conditions. The engine control system operates the low-pressure fuel pump to deliver more fuel than will be consumed by the internal combustion engine, with excess fuel being returned to the fuel tank through the return line and valve.

### BRIEF DESCRIPTION OF THE DRAWINGS

FIG. 1 is a schematic diagram of an LPG fuel delivery system according to aspects of the disclosure;

FIG. 2 is an exterior perspective view of one embodiment of a high-pressure fuel pump configured for delivery of LPG to a direct injection system according to aspects of the disclosure;

FIG. 3 is a vertical sectional view through the high-pressure fuel pump of FIG. 2, taken in a plane extending through the low-pressure LPG inlet, control valve and pumping plunger;

FIG. 4 is a horizontal sectional view through the high-pressure fuel pump of FIG. 2, taken in a plane extending through a the low-pressure LPG inlet, high-pressure outlet, pumping chamber, control valve and return connection; and

FIG. 5 is a graph of an example liquid-gas phase change curve for LPG in accordance with an embodiment of the present disclosure.

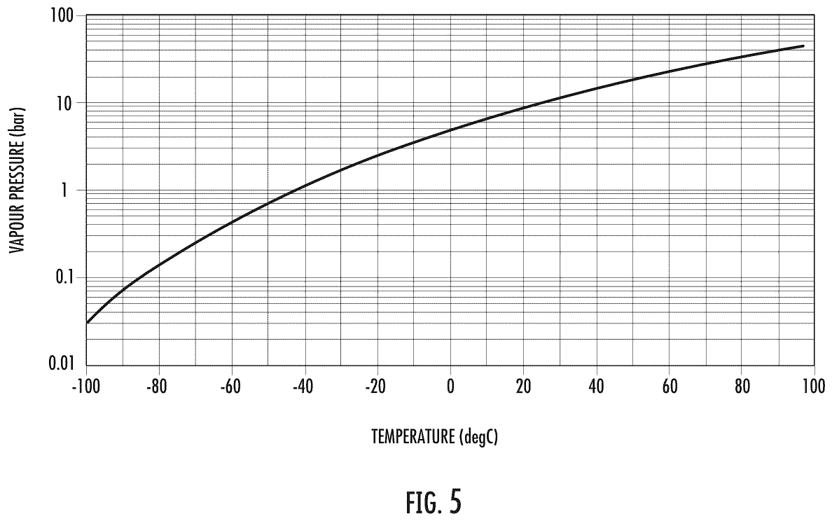

### DETAILED DESCRIPTION

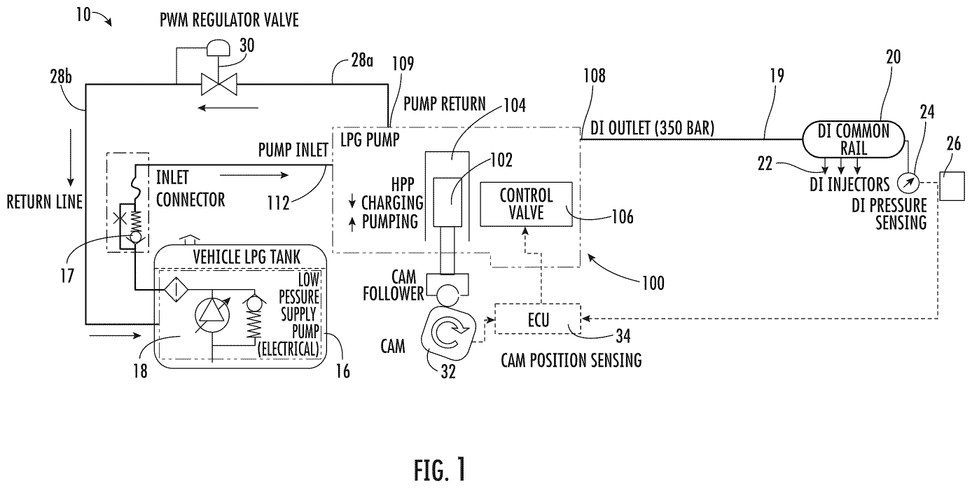

The following description relates to a fuel system for an internal combustion engine, such as the exemplary system 10 illustrated in FIG. 1. The fuel system 10 is configured to supply high-pressure liquid-phase liquefied petroleum gas (LPG) to a direct fuel injection system 12. Operation and control of a direct injection fuel system is well-known to those skilled in the art and will be described here only to the extent needed to explain novel features of the disclosed fuel system 10 and high-pressure fuel pump 100. Direct injectors 14 are positioned to inject fuel directly into the combustion chambers of a multi-cylinder internal combustion engine (not shown). Direct injection systems are characterized by high fuel pressures necessary to rapidly deliver finely atomized fuel to the combustion chamber, where the fuel is mixed with air and ignited. Direct injection is commonly used to deliver liquid fuels such as gasoline or diesel fuel. Although the exemplary fuel system 10 and high-pressure fuel pump 100 are described in the context of a direct injection fuel system, it is not limited to use only with direct injection.

The disclosed exemplary fuel system 10 is configured to address some of the unique properties of LPG. The disclosed fuel system 10 includes a fuel tank 16 for LPG. It will be understood that the LPG in the tank 16 will be partially in a liquid-phase and partially in a gaseous-phase, with the proportions depending on how much LPG is in the tank 16 as well as the pressure and temperature within the tank 16. Since the liquid-phase has a greater density, the liquid-phase will accumulate in the bottom of the tank 16 by force of gravity, with the gaseous-phase at the top of the tank 16. A low-pressure supply pump 18 is arranged to pump liquid-phase LPG from the bottom of the tank 16. The supply pump 18 may be arranged in the tank 16 as shown, or may be outside the tank 16 with a pump inlet communicating with a point near the bottom of the tank 16.

This disclosure may refer to gravitational force or a gravitational direction. Gravitational direction as used in this disclosure is always towards the center of the mass of the object exerting the gravitational pull; on Earth, this means “downward” as gravity pulls objects towards the Earth's center. In this disclosure, “gravitationally below” refers to a position in a gravitational direction closer to Earth's center. Gravity plays a role in the disclosed fuel system 10 and high-pressure fuel pump 100 because liquid-phase LPG tends to settle at the bottom of a container, while gaseous-phase LPG tends to accumulate at the top of the container. Separation of LPG into liquid-phase below gaseous-phase will occur n any space where both liquid-phase and gaseous-phase LPG are present. If the objective is to pump liquid-phase LPG from a tank, then it makes sense to draw LPG from the bottom of the tank.

With reference to FIG. 1, the supply pump 18 may be arranged in the fuel tank 16 to pump liquid-phase LPG to the inlet 102 of a high-pressure fuel pump 100. The high-pressure fuel pump 100 compresses the liquid-phase LPG to a high pressure in the range of 100-500 bar and delivers the high-pressure liquid-phase LPG to an accumulator such as a common rail 20. From the common rail 20, the liquid-phase LPG is injected into the combustion chambers (not shown) by direct fuel injectors 22. The common rail 20 may include a pressure sensor 24 and/or pressure regulating valves (PRV) 26 to maintain a predetermined fuel pressure in the rail 22 and allow excess pressure to bleed off and be returned to the fuel tank 16.

The disclosed fuel system 10 is configured to circulate LPG from the fuel tank 16, through the low-pressure inlet side of the high-pressure fuel pump 100 and back to the fuel tank through a return line 28a, 28b and regulating valve 30. According to aspects of the disclosure, a regulator valve 30 is arranged in the return line 28a, 28b and configured to maintain a pre-determined pressure upstream of (behind) the regulating valve 30. The region of pressure maintained by the regulating valve 30 includes the low-pressure, inlet side of the high-pressure fuel pump 100. Maintaining a pre-determined pressure on the inlet side of the high-pressure pump 100 prevents excess vaporization of LPG at the inlet side of the high-pressure pump 100. Fuel vapor at the inlet of a high-pressure pump results in loss of a lubricating film of liquid-phase LPG, loss of pumping efficiency because gaseous-phase LPG is compressible and may result in catastrophic pump failure. The condition of fuel vapor in a high-pressure fuel pump resulting in fuel delivery failure is sometimes referred to as “vapor lock.”

The high-pressure fuel pump 100 in the disclosed fuel system is a single-piston type fuel pump similar to fuel injection pumps used for gasoline direct injection (GDI). One example of a high-pressure fuel pump 100 is driven by a cam 32 rotated by the engine (not shown). Alternative configurations of a high-pressure pump, for example driven by an electric motor are compatible with the disclosed fuel system 10. In a piston-type high-pressure fuel pump, each rotation of the cam 32 drives the pumping piston (plunger) 102 in a repeating cycle of intake and pumping phases. In the intake phase, the plunger 102 is withdrawn from the pumping chamber 104, expanding the volume of the pumping chamber 104 which draws fuel through a control valve 106 into the pumping chamber 104. In the pumping phase, the plunger 102 is advanced into the pumping chamber 104, reducing the volume of the pumping chamber 104 and compressing the fuel in the chamber 104. The pumping plunger 102 may include a circumferential seal 103 positioned between the pumping end and driven end of the pumping plunger 102. Pressurized fuel passes through a high-pressure pump outlet 108 to the common rail 20. The disclosed cam 32 has four lobes and produces four intake and four pumping phases per rotation of the cam 32. Other cam configurations are possible.

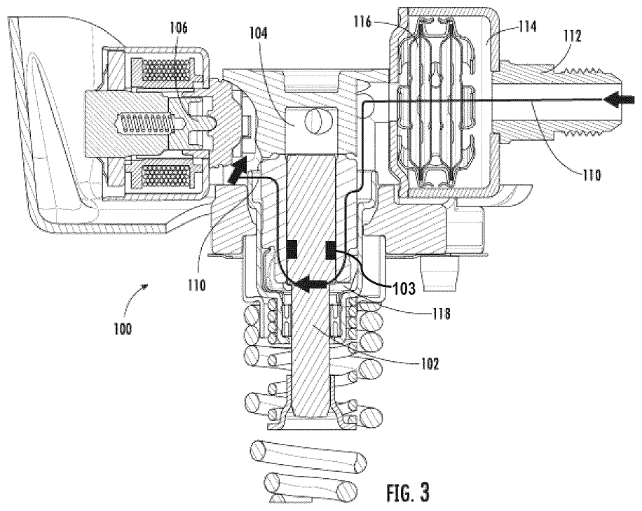

The high-pressure fuel pump 100 includes a control valve 106 that opens and closes under control of the ECU 34 to determine the quantity of fuel compressed by the high-pressure fuel pump 100 in each pumping phase. This may be accomplished by the control valve 106 defining a variable opening through which fuel is drawn into the pump. Alternatively, the control valve 106 may have a fixed opening but may be held open for part of a pumping phase, allowing some fuel in the pumping chamber 104 to return to the inlet side of the high-pressure pump 100. The high-pressure pump 100 includes an infeed passage 110 illustrated in FIG. 3. The infeed passage 110 extends from the pump inlet 112, through an optional damper chamber 114 containing gas-filled metal dampers 116, through a seal chamber 118 surrounding a lower end of the pumping plunger 102 and an upstream side of the control valve 106. The high-pressure side of the high-pressure pump 100 includes the pumping chamber 104, high-pressure outlet 108 and fuel line 19 communicating with the common rail 20 (or other downstream consumer of pressurized fuel). The low-pressure and high-pressure sides of the high-pressure pump 100 are intermittently separated by the control valve member 107, with the control valve member 107 in an open position during the intake phase and closed during at least part of the pumping phase. Pressurized fuel opens an outlet check valve arranged in the high-pressure outlet 108, allowing pressurized fuel to flow to the common rail 20. In the disclosed high-pressure pump 100, the high-pressure outlet 108 includes the outlet check valve and a pressure relief valve to relieve excess pressure downstream of the high-pressure pump. An outlet check valve and pressure relief valve do not need to be situated in the outlet fitting and may alternatively be positioned in the high-pressure pump body or in the high-pressure line 19 to the common rail 20.

The disclosed fuel system 10 is connected to an engine control unit 34 (ECU) that receives information about engine operating conditions and sends control signals to the supply pump 18 and control valve 106 of the high-pressure pump 100 to match fuel delivery to the common rail 20 with fuel consumption. Relevant engine operating conditions include but are not limited to engine rotational speed, throttle position, and cam position. In the context of the disclosed fuel system 10, fuel pressure and temperature at the common rail 20 and at the pump inlet 110 are also relevant operating conditions. Sensors (not shown) may be arranged to measure pressure and temperature at the pump inlet 110 and common rail 20, with this information provided to the ECU 34 for use in controlling the supply pump 18 and high-pressure pump 100.

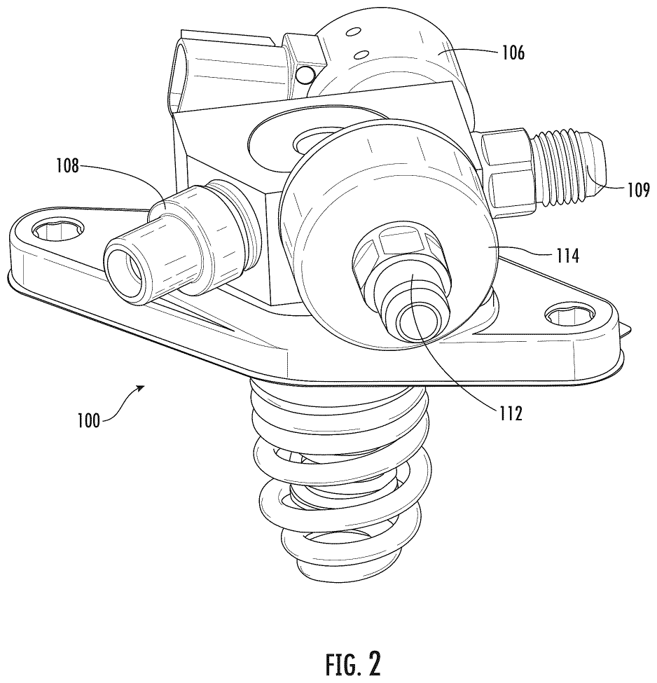

As shown in FIG. 2, an exemplary high-pressure fuel pump 100 has three fuel connections, an inlet 112 for receiving liquid-phase LPG from the supply pump 18, a high-pressure outlet 108 for fuel to the common rail 20, and a return connection 109 back to the fuel tank 16. The inlet and return connections 112, 109 fluidly communicate with the low-pressure inlet side of the high-pressure pump 100. The low-pressure inlet side of the high-pressure pump 100 is in a region between the outlet check valve 17 of the supply pump 16 and the regulating valve 30 in the return line 28a. Pressure in this region is determined by the regulating valve 30 and the supply pump 18 under control of the engine control unit 34. The pressure at the inlet side of the high-pressure pump 100 is maintained at a pressure in the range of 3 bar-6 bar (300-600 kPa), which helps control vaporization of LPG in the low-pressure side of the high-pressure pump 100. The pressure maintained upstream of the regulating valve 30 may vary with temperature, so the regulating valve 30 may be capable of opening at a variable pressure. The opening pressure of the regulating valve 30 may be controlled by the ECU using pulse width modulation (PWM) to control power delivered to the regulating valve.

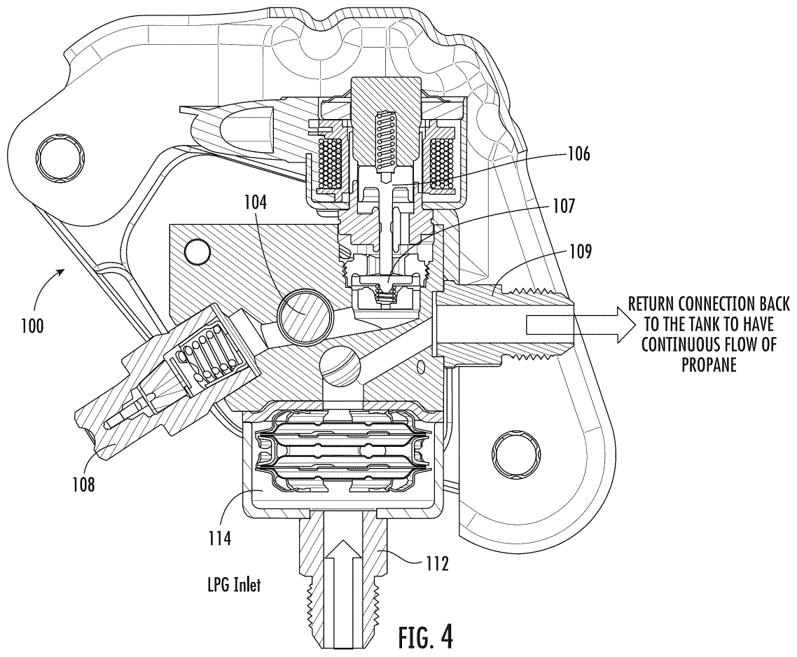

With reference to FIGS. 2-4, the high-pressure pump 100 is intended to be mounted with the axis of the pumping plunger 102 in a vertical or near-vertical orientation and the inlet 112 and return connection 109 above the pumping chamber 104. As can be seen in FIGS. 3 and 4, the pump inlet 112 and return connection 109 communicate with the low-pressure side of the high-pressure pump 100 at a position above most of the infeed passage 110 leading to the inlet side of the control valve 106. Where the inlet 112 joins the infeed passage 110, flow to the infeed passage 110 is in a downward direction. As shown in FIGS. 3 and 4, the inlet 112 and return connection 109 are at roughly the same height and both are above the pumping chamber 104. This arrangement of fuel flow allows liquid-phase LPG to descend into the seal chamber 118 surrounding a lower end of the pumping plunger 102, while any gaseous-phase LPG remains above the infeed passage 110 and is returned to the fuel tank through the return connection 109 and regulating valve 30. Separation of liquid-phase LPG from gaseous-phase LPG in the disclosed high-pressure pump 100 depends on the greater density of the liquid-phase and a vertical or near vertical orientation of the high-pressure pump so the return connection 109 is at least partially above the infeed passage 110. The configuration of the disclosed high-pressure pump separates gaseous-phase LPG from liquid-phase LPG even if LPG delivered by the supply pump 18 is a mixture of liquid and gaseous-phase LPG.

What is claimed:

1. A high-pressure fuel pump comprising:
an inlet receiving LPG fuel from a fuel tank and communicating with an infeed passage, said LPG fuel comprising a mixture of liquid-phase LPG and gaseous-phase LPG;
a pumping chamber in selective fluid communication with the infeed passage;
a pumping plunger that reciprocates in the pumping chamber between an intake phase that expands a volume of the pumping chamber to draw fuel into the pumping chamber and pumping phase that reduces the volume of the pumping chamber to compress fuel to a higher pressure to deliver pressurized liquid-phase LPG through a discharge valve to a high-pressure outlet;
a return connection to the fuel tank, said return connection in communication with the infeed passage,
wherein the infeed passage is configured to direct liquid-phase LPG to flow toward the pumping chamber and gaseous-phase LPG to the return connection.

2. The high-pressure fuel pump of claim 1, wherein a first portion of the infeed passage is gravitationally below the inlet and the return connection so that liquid-phase LPG descends into the first portion and gaseous-phase LPG flows to the return connection.

3. The high-pressure fuel pump of claim 1, comprising;
an inlet valve arranged to open during the intake phase and close during the pumping phase selectively connecting the pumping chamber to the infeed passage so that pressurized liquid-phase LPG flows through the high-pressure outlet.

4. The high-pressure fuel pump of claim 1, comprising a seal surrounding the pumping plunger at a position between a pumping end of the plunger situated in the pumping chamber and a driven end of the pumping plunger opposite the pumping end,
wherein the infeed passage directs liquid-phase LPG through a seal chamber surrounding the pumping plunger before liquid-phase LPG is delivered to the pumping chamber.

5. The high-pressure fuel pump of claim 1, comprising:
an inlet metering valve in the infeed passage for delivering metered quantities of liquid-phase LPG to the pumping chamber, said inlet metering valve having an inlet metering valve member movable between an open position corresponding to maximum flow and a closed position of the metering valve corresponding to zero flow to the pumping chamber.

6. An LPG fuel system comprising:
a fuel tank defining a volume for storage of pressurized LPG fuel, said LPG fuel having a liquid-phase at a gravitational bottom of the fuel tank and a gaseous phase at a gravitational top of the fuel tank;
a low-pressure supply pump arranged to pump liquid-phase LPG fuel through a fuel delivery line;
a high-pressure fuel pump comprising:
an inlet receiving LPG fuel from the fuel delivery line and communicating with an infeed passage, said LPG fuel at said inlet comprising a mixture of liquid-phase LPG and gaseous phase LPG;
a pumping chamber in selective fluid communication with the infeed passage;
a pumping mechanism that compresses liquid-phase LPG fuel to deliver pressurized liquid-phase LPG through a discharge valve to a high-pressure outlet; and
a return connection to the fuel tank, said return connection in communication with the infeed passage,
a return line receiving LPG fuel from the return connection and delivering LPG fuel back to the fuel tank, said return line passing through a valve configured to maintain a predetermined LPG fuel pressure between the valve and the infeed passage;
an internal combustion engine with fuel injectors arranged to inject liquid-phase LPG fuel into combustion chambers of the internal combustion engine, said fuel injectors receiving pressurized liquid-phase LPG fuel from the high-pressure outlet;
an engine control system configured to monitor engine operating conditions including engine rotational speed and power output.

7. The LPG fuel system of claim 6, comprising:
sensors configured to detect the temperature and pressure of LPG fuel in the return line, and
a control system receiving temperature and pressure readings from the sensors and generate control signals,
wherein the valve is configured to vary the predetermined pressure depending on control signals from the control system.

8. The LPG fuel system of claim 6, wherein said low-pressure supply pump is regulated by the engine control system to deliver LPG fuel at a rate dependent upon the engine operating conditions, said engine control system operating the low-pressure fuel pump to deliver more fuel than will be consumed by the internal combustion engine, with excess fuel being returned to the fuel tank through the return line and valve.
